(19) United States
(12) Patent Application Publication
(10) Pub. No.: US 2001/0028189 A1
(43) Pub. Date: Oct. 11, 2001

(54) Pivot mechanism for a vehicle seat

(75) Inventor: Mario Klein, Kaiserlautern (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: KEIPER GMBH & CO

(21) Appl. No.: 09/815,231

(22) Filed: Mar. 22, 2001

(30) Foreign Application Priority Data
Mar. 23, 2000 (DE) 100 14 499.3

(51) Int. Cl. B60N 2/20

(52) U.S. Cl. 297/378.12

(57) ABSTRACT

In a pivot mechanism for a vehicle seat, comprising at least two members adapted for rotation relative to each other about a seat back pivot axle and for engagement by a locking device, at least one flexible actuation element for disengaging the locking device, whose line of action intersects the seat back pivot axle, and at least one deflection means for the flexible actuation element, one end of the flexible actuation element is attached to a member of the mechanism.

### BACKGROUND OF THE INVENTION

The present invention relates to a pivot mechanism for a vehicle seat.

DE 33 40 697 C2 discloses a known pivot mechanism, wherein for a free pivotal movement a flexible actuation element is provided in the form of a tightened cable. From a release lever, a cable segment extends past the pivot axle of the seat back, through a sleeve, around a pin of a locking element, again through the sleeve, past the other side of the pivot axle of the seat back, to a clamping sleeve, which is used to secure the cable end to the first-mentioned cable segment. The thus-formed loop provides for a balanced pull on the pin, with the line of action intersecting the pivot axle of the seat back. Consequently, the cable remains tightened during a swing motion of the pivot mechanism. While the manufacture of the components is cost-favorable, a great deal is still left to be desired.

### SUMMARY OF THE INVENTION

In accordance with one aspect, the present invention provides an improved pivot mechanism for a vehicle seat. The pivot mechanism has at least two members mounted for relatively pivoting about a seat back pivot axle, and a locking device mounted for moving between engaged and unengaged configurations. The locking device engages at least one of the members to restrict relative pivoting between the members during the engaged configuration, and the locking device allows relative pivoting between the members during the unengaged configuration. The pivot mechanism further includes at least one elongate, flexible actuation element mounted for moving in response to pulling. The flexible actuation element is mounted so that, in response to the pulling, it moves along a line of action that intersects the seat back pivot axle and moves the locking device from the engaged configuration to the unengaged configuration. The flexible actuation element extends at least partially around a deflection means, and an end of the flexible actuation element is attached to one of the members.

The pivot mechanism of the present invention reduces the occurrence of friction as a whole. As a result of mounting an end of a flexible actuation element to a member of the pivot mechanism, frictional forces are absent in this location. Such a mount may also be realized in a simple and cost-favorable manner. To make it easier to achieve the force and displacement compensation in the flexible actuation element, it is preferred to mount the actuation element on or in the region of the pivot axle of the seat back. To achieve favorable frictional conditions, this is accomplished preferably by attaching the flexible actuation element to a pulley integral with a member of the mechanism, or to another curved arrangement, which is arranged in concentric relationship with the pivot axle of the seat back. Only a slight sliding friction will occur on the pulley integral with the member of the mechanism, when the flexible actuation element is actuated, if same is guided after a deflection past the pulley integral with the member of the mechanism. The deflection means for the actuation element may be movable along the line of action, which is possible to realize in a simple and cost-favorable manner by a rotatably supported pulley, which is arranged for sliding or pivotal movement. In the case of the rotating pulley, frictional forces will occur only on the pulley.

In a preferred embodiment, the flexible actuation element comprises two segments arranged side by side, between which the line of action extends. The operative force in the actuation element will then distribute itself over two segments. A preferred, geometrically simple arrangement will result when the segments extend between two pulleys. During a pivoting motion of the pivot mechanism, a length of one segment winds onto the pulley integral with the member of the mechanism, and a length of the other segment unwinds from the pulley integral with the member of the mechanism, whereas at the other end of each segment, a length is deflected on the rotatable pulley. In the instance of the two segments, the deflected and unwound and wound lengths are preferably identical. This ensures that the line of action continues to extend between these segments. With this arrangement, a tackle is realized, which leads as a function of the orientation during the disengagement to a reduction of the necessary actuation force or the necessary distance.

The pivot mechanism of the present invention may be used in vehicle seats, in particular automobile seats, which comprise a seat back adapted for free pivotal movement or forward tilting, in particular such seats that have an additional inclination adjustment of the seat back or cable lines extending in part in open receptacles. In the instance of an inclination adjustment of the seat back, the invention prevents an unwanted release of a locking engagement of the free pivoting function.

### BRIEF DESCRIPTION OF THE DRAWINGS

In the following, the invention is described in greater detail with reference to two embodiments illustrated in the drawings, in which:

FIG. 1 is a side view of a first embodiment in a locked state of use, the lower member of the mechanism being shown only in part;

FIG. 2 is a perspective view of a stationary pulley in the direction of arrow II of FIG. 1;

FIG. 3 is a side view of the first embodiment shown only in part in a forward pivoted state;

FIG. 4 is a perspective view of a sliding block;

FIG. 5 is a side view of a second embodiment in a locked state of use, the lower member of the mechanism being shown only in part; and

FIG. 6 is a side view of the second embodiment shown only in part in a forward pivoted state.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The first embodiment relates to a pivot mechanism 1 for a vehicle seat with a seat back adapted for free pivotal movement and adjustment in its inclination, for example, for a rear seat bench. The pivot mechanism comprises a lower member 3 and an upper member 4, which can be pivoted relative to the lower member 3 about a pivot axle 6 supported in the lower member 3, when the pivot mechanism 1 is disengaged. The lower member 3 is mounted to the seat portion on one side of the vehicle seat, whereas the upper member 4 is connected on this side to the seat back. Depending on the partition of the vehicle seat, a plurality of pivot mechanisms 1 are used. The usual arrangement in the vehicle and the normal traveling direction define the directions, as used in the following.

A cover plate 9 is rigidly connected to the lower member 3, with the pivot axle 6 of the seat back extending therethrough. The upper member 4 is arranged in the region of seat back pivot axle 6 between lower member 3 and cover plate 9. At the end, which directs downward in the locked state of use of the pivot mechanism 1, the upper member 4 comprises a toothed portion 4′. The toothed portion 4′ cooperates with a pawl 10, which is shown in the drawing only in phantom lines and is supported in the lower member 3. This pawl 10 is held by a tensioning cam 11 supported in the lower member 3. Supported in the cover plate 9 in concentric relationship with tensioning cam 11 is a two-arm entrainment lever 13, which connects by means of a sectional transmission bar 15 to a corresponding entrainment lever 13 of a pivot mechanism on the other side of the vehicle seat. Various springs keep the foregoing components engaged in the locked state of the pivot mechanism 1. In so doing, one arm of the entrainment lever 13 lies against the lower edge of cover plate 9.

In the upper member 4, above the seat back pivot axle 6, a slot-shaped guideway 20 extends in alignment with the seat back pivot axle 6. In this guideway 20, a sliding block 22 is inserted for movement therein. In the locked state of pivot mechanism 1, the sliding block 22 is located somewhat above the lower end of guideway 20. The sliding block 22, which is made of plastic, comprises a U-section, with the legs 24 thereof being provided with projections in the way of a clip. The sliding block 22 is inserted through guideway 20 from the side facing cover plate 9, with its elastic legs slightly compressed, so that the projections are able to engage behind the upper member 4 on the side facing the lower member 3. On the side facing the cover plate 9, a cylindrical, stepped pin 26 projects from sliding block 22, which is provided on its free end, likewise in the way of a clip, with legs and projections serving as a locking means.

A first movable deflection pulley 30 associated to upper member 4 is slipped over pin 26 and held by the described locking means. The first deflection pulley 30 is rotatably supported on pin 26. A second fixed deflection pulley 33 associated to the lower member 3 is arranged on cover plate 9 in concentric relationship with the seat back pivot axle 6. On their circumference, both deflection pulleys 30 and 33 comprise an annular groove for receiving a cable 35. The cable 35 acting as a flexible actuation element, is attached at its one end to an arm of entrainment lever 13. In a first segment 35′, it extends to the second deflection pulley 33, and lies against the rearward directed side thereof. In a second segment 35″, it extends to the first deflection pulley 30, and contacts it over the upper half of the circumference thereof. In a third segment 35′″, it extends from the forward directed side of the first deflection pulley 30 to the forward directed side of the second deflection pulley 33, lies against same, and connects to the downward directed side of the second deflection pulley 33 by means of a pin 37 or a cable line fitting.

A further cable 38 acting likewise as an actuation element is arranged on sliding block 22, and extends to a release lever with a suitable handle. In the place of the further cable 38, it is also possible to use a rigid bar. The spring provided on entrainment lever 13 sees to it that both cables 35 and 38 are tightened. For a disengagement, the line of action of a tensile force extends through the further cable 38 in the center between the segments 35″ and 35′″, vertically intersects the seat back pivot axle 6, and extends to the mounting point of cable 35 on entrainment lever 13.

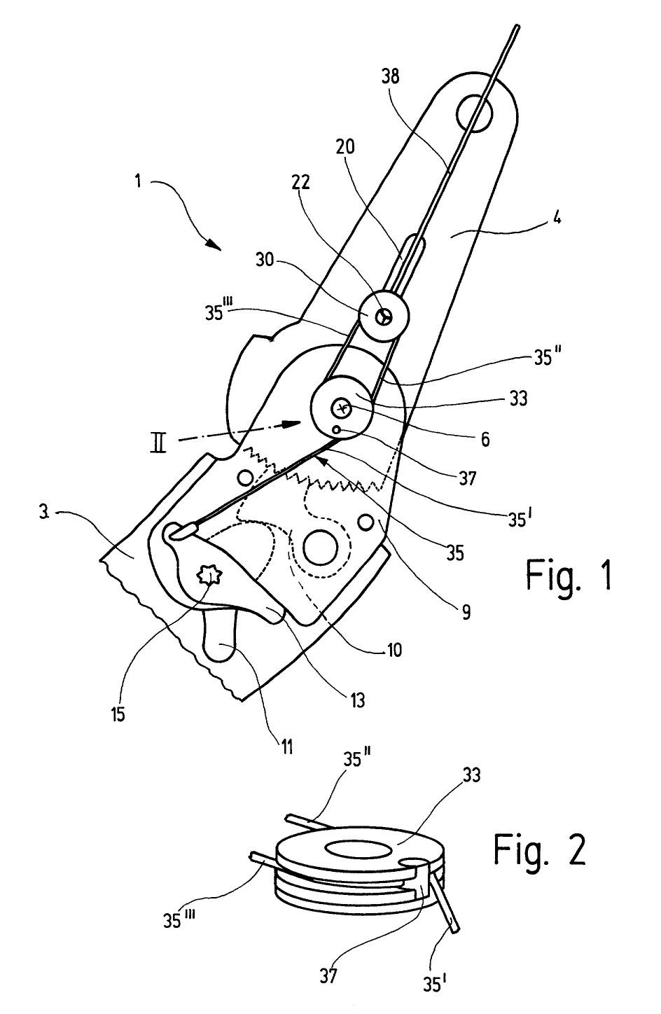

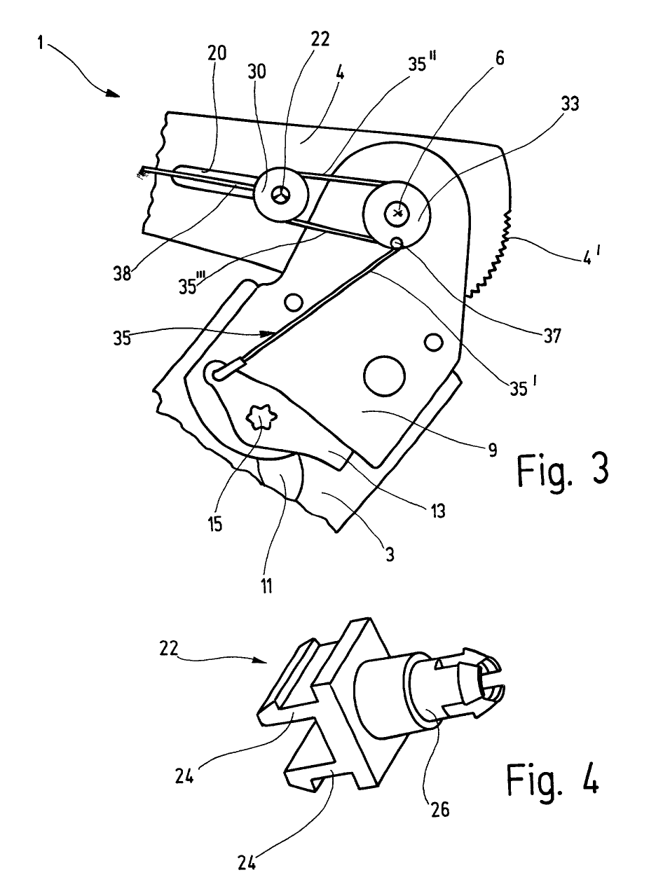

Starting from the locked state shown in FIG. 1, a pull on the further cable 38 causes the sliding block 22 extending for displacement in guideway 20 to pull upward. The third and second cable segments 35′″ and 35″ lengthen, thereby shortening the first segment 35′, i.e. the cable 35 on entrainment lever 13 pulls. As a result, the entrainment lever 13 rotates (in the drawing clockwise), and disengages the tensioning cam 11 from pawl 10, which releases the toothed portion 4′ of upper member 4. Via the transmission bar 15, the movement of entrainment lever 13 is transmitted to the other side of the vehicle seat, where a corresponding disengagement occurs. It is now possible to pivot the seat back with the upper member 4 forward to adjust a different inclination, or to change over to the freely movable state. In the latter instance, the existing springs cause the components to lock again in their initial position and to tighten cables 35 and 38. This state is shown in FIG. 3. As a result of the tackle-type arrangement, the cable 35 moves in the first segment 35′ twice the distance as further cable 38.

When the upper member 4 is now pivoted further toward the front, the third segment 35′″ of cable 35 unwinds somewhat from the second deflection pulley 33 integral with the lower member, and is entrained at the other end by the first deflection pulley 30. A length of the second segment 35″ is released by the first deflection pulley 30, and wound at the other end onto the second deflection pulley 33. However, the cable 35 remains tightened, since the sum of the distances reflecting the line of action, namely the distance between the entrainment lever 13 and seat back pivot axle 6 plus the distance between the seat back pivot axle 6 and pin 26 of sliding block 22, remains constant. As the upper member 4 of the mechanism is pivoted back, the second and third segments 35″ and 35′″ displace in the opposite way. Finally, a mechanism not shown in greater detail causes the pawl 10 to engage again the toothed portion 4′, so that the pivot mechanism 1 is locked.

The second embodiment relates to a pivot mechanism 101, which corresponds in its construction and function to the pivot mechanism 1 of the first embodiment, unless otherwise described in the following. Like parts are therefore identified by numerals increased by 100. In a corresponding manner, a lower member 103 and an upper member 104 of the mechanism are arranged for rotation relative to each other about a seat back pivot axle 106. Between the lower member 103 and a cover plate 109, a locking device is provided for cooperating with a toothed portion 104′ of the upper member 104. This locking device comprises a pawl supported on the lower member 103, a tensioning cam 111 for securing the pawl, and a two-arm entrainment lever 113 for moving the tensioning cam 111. A sectional transmission bar 115 connects the entrainment lever 113 to a corresponding entrainment lever on the other side of the vehicle seat.

A first deflection pulley 131 associated to the lower member 103 is rotatably supported on an arm of entrainment lever 113, for example, on a pin with locking means corresponding to pin 26 of the first embodiment. A second deflection pulley 132 associated to the upper member 104 is corotationally mounted on seat back pivot axle 106, so that it rotates at the same time as the upper member 104 is pivoted. A cable 136 extends as a flexible actuation element from a release lever with a handle, in a first segment 136′, from the top to the rearward directed side of the second deflection pulley 132 and lies against same. A second cable segment 136″ extends to the first deflection pulley 131, and surrounds same while contacting its downward directed side. A third cable segment 136′″ extends to the forward directed side of the second deflection pulley 132, contacts same, and is attached thereto on the upward directed side by means of a pin 137.

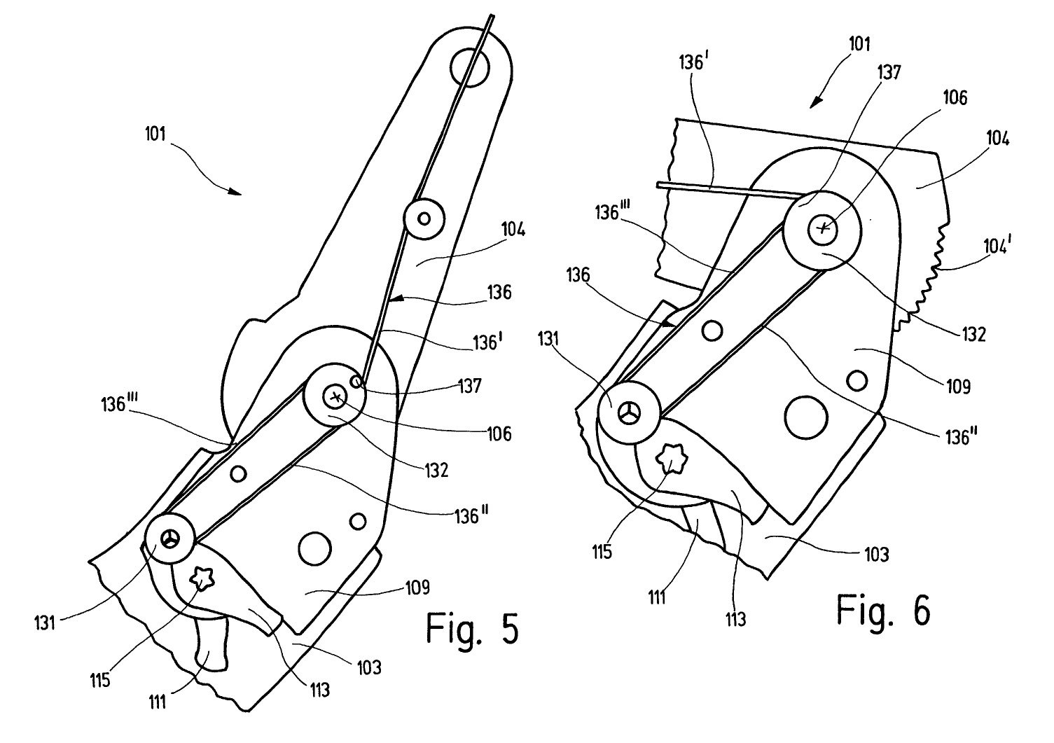

Starting from a locked state of use as shown in FIG. 5, a pull on cable 136 causes the first deflection pulley 131 with entrainment lever 113 to pull upward in a swing motion due to the cable end held on the second deflection roll 132 integral with the upper member. In so doing, the locking device releases the upper member 104. As a result of the tackle-type arrangement, one has to pull the cable 136 with only half as much the force as the spring force on entrainment lever 113. FIG. 6 shows a situation when the upper member 104 is pivoted slightly forward, and the components are again in their initial position due to the effects of the springs. However, the pawl is no longer engaged. As the upper member 104 is further pivoted, the third segment 136′″ unwinds somewhat from the second deflection pulley 132, and is entrained by the first deflection pulley 131. The second segment 136″ unwinds somewhat from the first deflection pulley 131, and winds on the second deflection pulley 132. However, the cable remains tightened, since between the entrainment lever 113 and the seat back pivot axle 106, the distance extending on the line of action of the tensile force in the plane perpendicular to the seat back pivot axis 106, remains constant.

In a modification of the two embodiments, an intermediate member is provided in addition to the lower and upper members of the mechanism. For a free pivotal movement, this intermediate member engages one of the other two members of the mechanism in the above-described manner. The intermediate member is connected to the other member of the mechanism by a locking device or gearing. The pivot mechanism, which is thus designed and constructed as a locking or a wobble arrangement, additionally permits adjusting the inclination of the seat back. The arrangement of the cable in accordance with the invention also ensures in this instance that the cable remains tightened, when the inclination of the seat back is changed.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A pivot mechanism for a vehicle seat, comprising:
at least two members mounted for relatively pivoting about a seat back pivot axle;
a locking device mounted for moving between engaged and unengaged configurations, with the locking device engaging at least one of the members to restrict relative pivoting between the members during the engaged configuration, and the locking device allowing relative pivoting between the members during the unengaged configuration; and
at least one elongate, flexible actuation element mounted so that, in response to pulling, the flexible actuation element moves along a line of action that substantially intersects the seat back pivot axle and moves the locking device from the engaged configuration to the unengaged configuration, wherein the flexible actuation element extends at least partially around at least one deflection means, and an end of the flexible actuation element is attached to one of the members.

2. A pivot mechanism according to claim 1, wherein the attachment between the end of the flexible actuation element and the one of the members is in the region of the seat back pivot axle.

3. A pivot mechanism according to claim 1, wherein the attachment between the end of the flexible actuation element and the one of the members includes an attachment between the end of the flexible actuation element and a pulley which is concentric with the seat back pivot axle.

4. A pivot mechanism according to claim 3, wherein the pulley is fixed with respect to the one of the members.

5. A pivot mechanism according to claim 1, wherein the deflection means is mounted for moving along the line of action.

6. A pivot mechanism according to claim 5, wherein the deflection means includes a rotatably supported pulley.

7. A pivot mechanism according to claim 1, wherein the flexible actuation element includes two segments that are arranged side by side and between which the line of action extends.

8. A pivot mechanism according to claim 7, wherein the deflection means is arranged between the two segments of the flexible actuation element.

9. A pivot mechanism according to claim 7, further comprising a pulley, wherein the two segments of the flexible actuation element extend at least partially around the pulley so that a length of one of the two segments unwinds from the pulley and a length of the other of the two segments winds onto the pulley during relative pivoting between the members.

10. A pivot mechanism according to claim 9, wherein the attachment between the end of the flexible actuation element and the one of the members includes an attachment between the end of the flexible actuation element and the pulley, and the pulley is mounted concentrically with the seat back pivot axle for remaining stationary with respect to the one of the members during relative pivoting between the members.

11. A pivot mechanism according to claim 10, wherein the length of the one of the two segments that unwinds from the pulley is equal to the length of the other of the two segments that winds onto the pulley during relative pivoting between the members.

12. A pivot mechanism for a vehicle seat, comprising:
at least two members mounted for relatively pivoting about a seat back pivot axle;
a locking device mounted for moving between engaged and unengaged configurations, with the locking device engaging at least one of the members to restrict the relative pivoting between the members during the engaged configuration, and the locking device allowing relative pivoting between the members during the unengaged configuration; and
a block and tackle assembly connected between the locking device and an actuation element for moving the locking device from the engaged configuration to the unengaged configuration in response to movement of the actuation element, wherein the block and tackle assembly is for multiplying a distance that the actuation element moves or a force applied to the actuation element.

13. A pivot mechanism according to claim 12, wherein the block and tackle assembly includes a pair of deflection pulleys, and a cable entrained at least partially about each of the pulleys.

14. A pivot mechanism according to claim 13, wherein a first one of the deflection pulleys is mounted for movement along one of the members, and a second one of the deflection pulleys is mounted coaxially about the pivot axle, and wherein one end of the cable is attached to the locking device and a second end of the cable is attached to the second deflection pulley.

15. A pivot mechanism according to claim 13, wherein a first one of the deflection pulleys is mounted to the locking device, and a second one of the deflection pulleys is mounted coaxially about the pivot axle, and wherein the actuation element includes one end of the cable and a second end of the cable is attached to the second deflection pulley.

16. A vehicle seat, comprising:
at least two members mounted for relatively pivoting about a seat back pivot axle;
a locking device mounted for moving between engaged and unengaged configurations, with the locking device engaging at least one of the members to restrict relative pivoting between the members during the engaged configuration, and the locking device allowing relative pivoting between the members during the unengaged configuration; and
at least one elongate, flexible actuation element mounted so that, in response to pulling, the flexible actuation element moves along a line of action that substantially intersects the seat back pivot axle and moves the locking device from the engaged configuration to the unengaged configuration, wherein the flexible actuation element extends at least partially around at least one deflection means, and an end of the flexible actuation element is attached to one of the members.

17. A vehicle seat according to claim 16, wherein the deflection means includes a pulley mounted for rotating and moving along the line of action.

18. A vehicle seat according to claim 16, wherein the attachment between the end of the flexible actuation element and the one of the members includes an attachment between the end of the flexible actuation element and a pulley that is mounted concentrically with the seat back pivot axle for remaining stationary with respect to the one of the members during relative pivoting between the members.

19. A vehicle seat according to claim 18, wherein two segments of the flexible actuation element extend at least partially around the pulley so that a length of one of the two segments unwinds from the pulley and a length of the other of the two segments winds onto the pulley during relative pivoting between the members.

20. A vehicle seat according to claim 19, wherein the length of the one of the two segments that unwinds from the pulley is equal to the length of the other of the two segments that winds onto the pulley during relative pivoting between the members.
